(19) United States
(12) Patent Application Publication
(10) Pub. No.: US 2011/0134027 A1
(43) Pub. Date: Jun. 9, 2011

(54) INPUT DEVICE

(76) Inventors: Chih-Ming TSAO, Zhonghe City (TW); Ya-Ting Cheng, Zhonghe City (TW)

(21) Appl. No.: 12/960,052

(22) Filed: Dec. 3, 2010

(30) Foreign Application Priority Data
Dec. 4, 2009 (TW) 098141549

(51) Int. Cl. G06F 3/038; H04W 4/00; G09G 5/00

(52) U.S. Cl. 345/156; 370/328; 345/211

(57) ABSTRACT

Used in a multimedia operating system for controlling multiple computers, an input device includes a memory unit adapted for storing the ID codes of the computers, a control unit adapted for receiving an external switching signal and fetching the ID code from the memory unit subject to the content of the received external switching signal and then producing a switching packet containing the fetched ID code, a wireless transmitter and receiver unit adapted for transmitting the switching packet produced by the control unit to the computers, and a power supply unit adapted for providing the input device with the necessary working power supply.

This application claims the priority benefit of Taiwan patent application number 098141549, filed on Dec. 4, 2009.

### BACKGROUND OF THE INVENTION

1. Field of the Invention

The present invention relates to computer input devices and more particularly, to such an input device, which is practical for use in a multimedia operating system for controlling multiple computers from a remote place.

2. Description of the Related Art

In a factory, office or shop, multiple computers may be used. These computers may be respectively equipped with an independent display device and an independent input device, such as keyboard, mouse or microphone. This arrangement costs a lot, and complicates the control of the multiple computers.

To facilitate the control of multiple computers, a KVM switch may be used. A KVM allows a user to control multiple computers from a single keyboard, video monitor and mouse. Although multiple computers are connected to the KVM, typically a smaller number of computers can be controlled at any given time. Modern devices have also added the ability to share USB devices and speakers with multiple computers. Basically, a KVM switch uses a USB or PS2 interface device to transmit mouse or keyboard signal or data to multiple computers, an audio line to transmit audio signal to the computer in use, and a video line to transmit a computer video signal to a display device.

Therefore, most KVM switches simply support wired input devices. Before using one input device, it is necessary to install the mouse driver or keyboard driver in the KVM switch, or a new KVM switch shall be created. However, it is inconvenient to install a mouse driver or keyboard driver in a KVM switch. It is expensive to create a new KVM. Further, a wireless KVM switch is expensive, increasing the user's equipment cost.

Further, an input device used in a KVM switch can simply memorize the wireless receiver of the lastly matched remote computer. When using this input device to control and manage another remote computer, a new matching procedure is necessary to have the ID code of the newly selected remote computer be stored in its internal memory. For example, when going to manage different operating systems in a network environment or different users in different domains, it is necessary to install multiple computer devices, such as servers, to execute the management. When using a conventional input device to control or manage these servers, it is necessary to frequently establish matching when switching among the servers, complicating the management. Further, frequently matching the input device with the servers wastes much power supply, and the batter power of the input device will become low within a short period of time.

Further, connecting multiple computers, display devices and a wired input device to a KVM switch complicates the installation. Movement of the devices of the system is also inconvenient. When the number of the computers is increased, the number of the cables is relatively increased. In consequence, the KVM switch must provide a relatively larger space for accommodating a big number of cables. Subject to space restriction, the expansion of the KVM switch is limited.

Therefore, there is a strong demand to provide a measure that eliminates the aforesaid problems.

### SUMMARY OF THE INVENTION

The present invention has been accomplished under the circumstances in view. It is one object of the present invention to provide an input device, which allows a user to control multiple computers conveniently from a remote place in a wireless manner.

To achieve this and other objects of the present invention, an input device has installed therein a power supply module and a manipulation module. The power supply module provides the necessary working power supply. The manipulation module comprises a control unit, and a memory unit and a wireless transmitter and receiver unit respectively connected with the control unit. The memory unit is adapted for storing the ID codes of the computers. The ID code can be the address of the wireless receiver of the wireless transmitter and receiver unit of the respective computer, the serial number of the user of the respective computer or the serial number of the respective computer. When the control unit receives an external switching signal, it will fetch the corresponding ID code from the memory unit, and then transmitting a switching packet containing the fetched ID code to the computers to execute the switching operation. Thus, a user can control the computers wirelessly from a remote place. This wireless control manner is free from the limitation of the space arrangement of cables, and facilitates the control of the computers without the use of a KVM switch. Therefore, the use of the input device saves much equipment installation cost.

Further, when the manipulation module of the input device transmits a switching packet to the computers, the manipulation module of another input device having the same architecture will receive the switching packet and the control unit of the manipulation module of this another input device will fetch the ID code from the associating memory unit to execute the switching operation. Therefore, when one input device makes a switching operation, the other input devices of the same group will be synchronously switched.

### BRIEF DESCRIPTION OF THE DRAWINGS

FIG. 1 is a circuit block diagram of a manipulation module for an input device in accordance with the present invention.

FIG. 2 is a circuit block diagram of an input device in accordance with the present invention.

FIG. 3 is a circuit block diagram of an alternate form of the input device in accordance with the present invention.

FIG. 4 is an initialization flow chart of an input device in accordance with the present invention.

FIG. 5 is a switching operation flow chart of an input device in accordance with the present invention.

FIG. 6 is a block diagram illustrating the arrangement of multiple input devices and multiple computers in a multimedia operating system in accordance with the present invention.

FIG. 7 is an initialization flow chart of one input device in a multimedia operating system having multiple input devices and multiple computers.

FIG. 8 is a switching operation flow chart of one input device in a multimedia operating system having multiple input devices and multiple computers.

FIG. 9 is a flow chart illustrating an alternate form of the initialization of one input device in a multimedia operating system having multiple input devices and multiple computers.

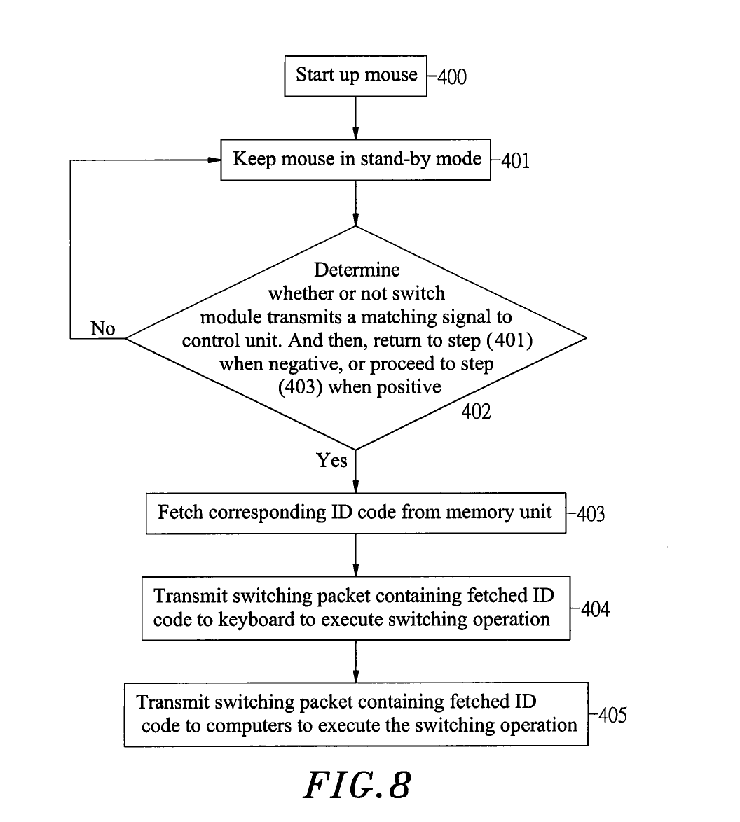

FIG. 8 is a flow chart illustrating an alternate form of the switching operation of one input device in a multimedia operating system having multiple input devices and multiple computers.

### DETAILED DESCRIPTION OF THE PREFERRED EMBODIMENT

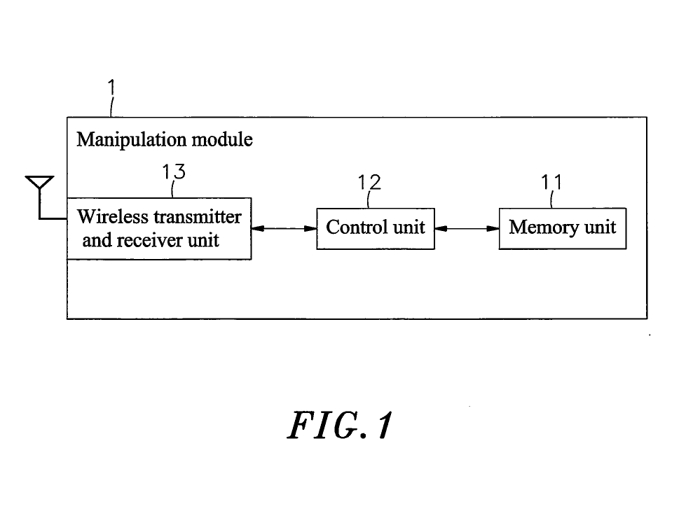

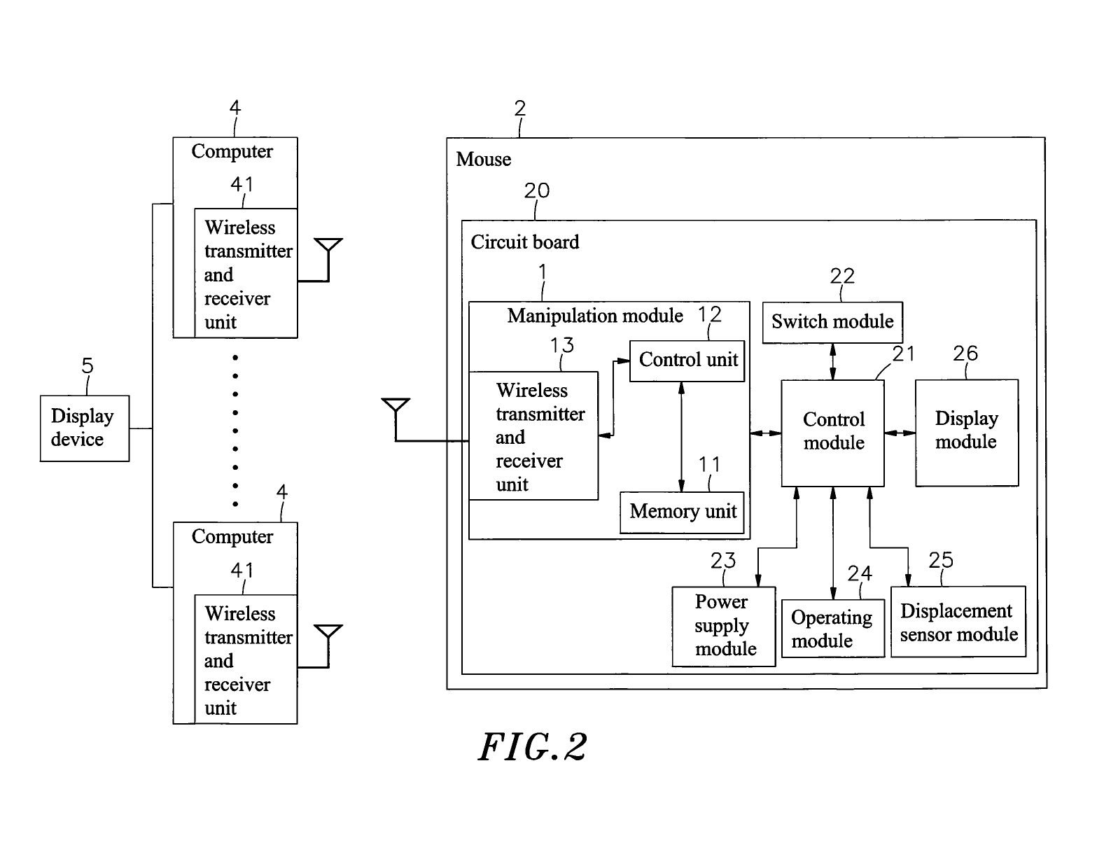

Referring to FIG. 1, an input device in accordance with the present invention comprises a manipulation module 1 adapted for transmitting a switch packet to multiple computers. The manipulation module 1 comprises a memory unit 11, a control unit 12 and a wireless transmitter and receiver unit 13.

The memory unit 11 has stored therein multiple ID (identification) codes that can be the address of the wireless receiver of the respective computer, user serial number, or computer serial number. The memory unit 11 can be a non-volatile computer storage device, such as flash or electronically erasable programmable read only memory (EEPROM). The memory unit 11 is electrically connected to the control unit 12. The control unit 12 can receive a switch signal from an external device, and then fetch at least one ID code from the memory unit 11 subject to the content of the received switch signal. The wireless transmitter and receiver unit 13 is electrically connected to the control unit 12, and adapted for transmitting each fetched ID code to the respective computer. Further, the control unit 12 can be a microprocessor, micro control unit (MCU), controller or central processing unit (CPU). Further, the wireless transmitter and receiver unit 13 can be a Bluetooth, radio frequency (RF) or Worldwide Interoperability for Microwave Access (WiMax) interface design.

Further, the manipulation module 1 is mounted inside an input device that can be a mouse, keyboard, hand writing device or earphone device. In one example of the present invention, as shown in FIG. 2, the input device is a mouse carrying therein the manipulation module 1.

Referring to FIG. 2, a multimedia operating system comprises an input device, for example, a mouse 2 carrying therein a manipulation module 1 that is constructed subject to the configuration shown in FIG. 1, a plurality of computers 4 and a display device 5. The mouse 2 comprises a circuit board 20 having installed therein the said manipulation module 1, a control module 21, a switch module 22, a power supply module 23, an operating module 24, a displacement sensor module 25 and a display module 26. The control module 21 is electrically connected with the manipulation module 1, the switch module 22, the power supply module 23, the operating module 24, the displacement sensor module 25 and the display module 26. The control module 21 can be a SoC (system-on-a-chip) type central processor or microcontroller having built therein, but not limited to, a memory and a register. The switch module 22 can be a DIP (dual in-line package) switch, or a cycle switch. If the switch module 22 is a DIP (dual in-line package) switch, it can be set of manual electric switches that are packaged in a group in a standard dual in-line package, for example, it can be an array of simple single-pole, single-throw contacts, which can be either on or off. If the switch module 22 is a cycle switch, a cycle button will be used for selecting among a small number of options. The cycle button can be a touch control button or mechanical button.

The power supply module 23 provides electric power to the internal modules of the mouse 2. The operating module 24 can be the combination of a scroll wheel, a left mouse button and a right mouse button. Further, the operating module 24 can be a capacitive touch panel design or resistance touch panel design, or a mechanical key structure, adapted for transmitting key switch signals to the computers 4 to execute an input operation, such as drop-down list or icon click.

Further, the operating module 24 can be set to define a different switching signal for a different number of key-clicking actions. In this case, the aforesaid switch module 22 can be omitted. The main point is the use of a module or device capable of producing switching signals. Such module or device can be a hardware design or software structure in any type or configuration.

Further, the displacement sensor module 25 can be an infrared sensor, or a CMOS (complementary metal-oxide semiconductor) or CCD (charge-coupled device) image sensor used with a LED or laser LED for measuring displacement of the mouse 2 in X-axis and Y-axis subject calculation by means of the control module 21. The light reflected by a target passes through the receiver lens and is focused on the sensor. The light quantity distribution of the entire beam spot entering the light receiving element is used to determine the beam spot center and identifies this as the target position. The sensor detects the peak value of the light quantity distribution of the beam spot for each pixel and identifies this as the target position. The detected displacement signal is transmitted to the computers 4 for cursor control.

Further, the display module 26 is adapted for displaying the current switching status and the power condition of the mouse 2. Further, the display module 26 can be a LED display device, 7-segment display device or TFT-LCD display device.

Further, each computer 4 comprises a wireless transmitter and receiver unit 41 for communication with the wireless transmitter and receiver unit 13 of the manipulation module 1 for sending or receiving signal, data or packet.

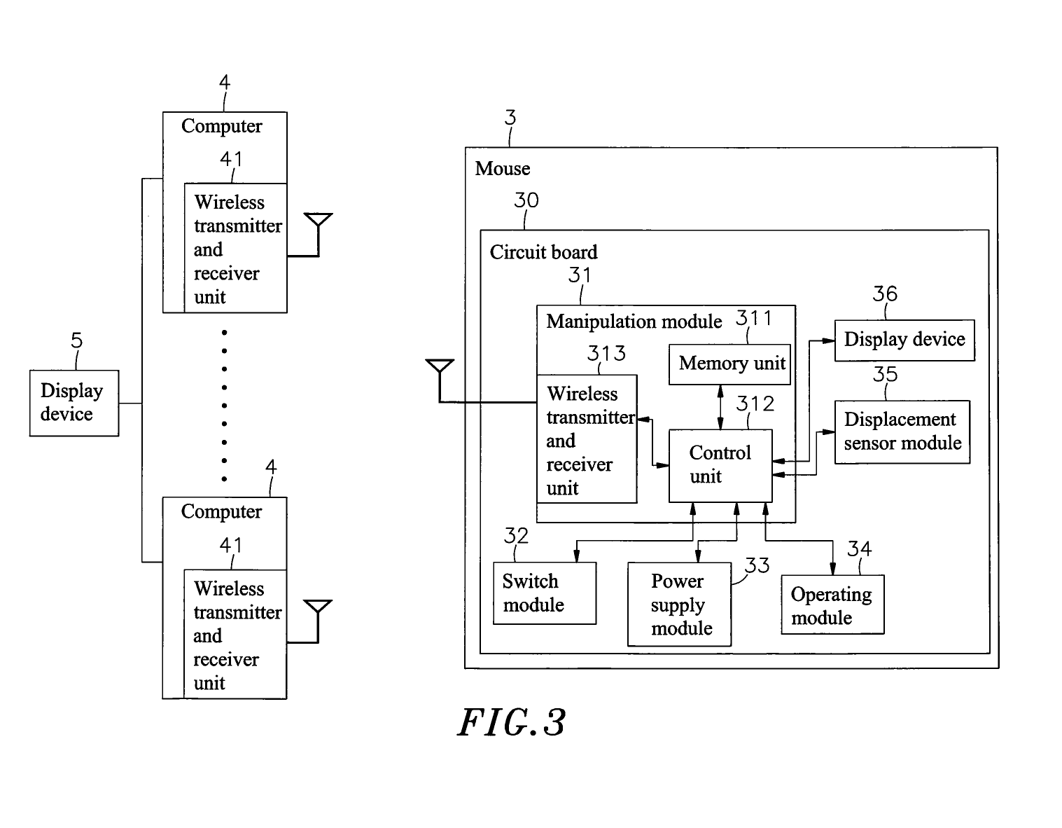

The memory unit 11 and control unit 12 of the manipulation module 1 can be configured to substitute for the functioning of the control module 22 of the mouse 2. In this case, the memory unit 11 and control unit 12 are capable of processing switching signals, key signals and displacement signals. FIG. 3 illustrates a multimedia operating system using an alternate form of the input device. As illustrated, the multimedia operating system comprises a plurality of input devices, for example, mice 3, a plurality of computers 4 and a plurality of display devices 5. Each mouse 3 comprises a circuit board 30, and a manipulation module 31, a switch module 32, a power supply module 33, an operating module 34, a displacement sensor module 35 and a display device 36 installed in the circuit board 30. The manipulation module 31 comprises a memory unit 311, a control unit 312 and a wireless transmitter and receiver unit 313. The control unit 312 is electrically connected with the switch module 32, power supply module 33, operating module 34, displacement sensor module 35 and display device 36 of each mouse 3. The memory unit 311, control unit 312 and wireless transmitter and receiver unit 313 of the manipulation module 31 have respectively the same functions as the memory unit 11, control unit 12 and wireless transmitter and receiver unit 13 of the aforesaid manipulation module 1.

Further, the switch module 32, power supply module 33, operating module 34, displacement sensor module 35 and display device 36 of each mouse 3 have respectively the same functions as the switch module 22, power supply module 23, operating module 24, displacement sensor module 25 and display module 26 of the aforesaid mouse 2.

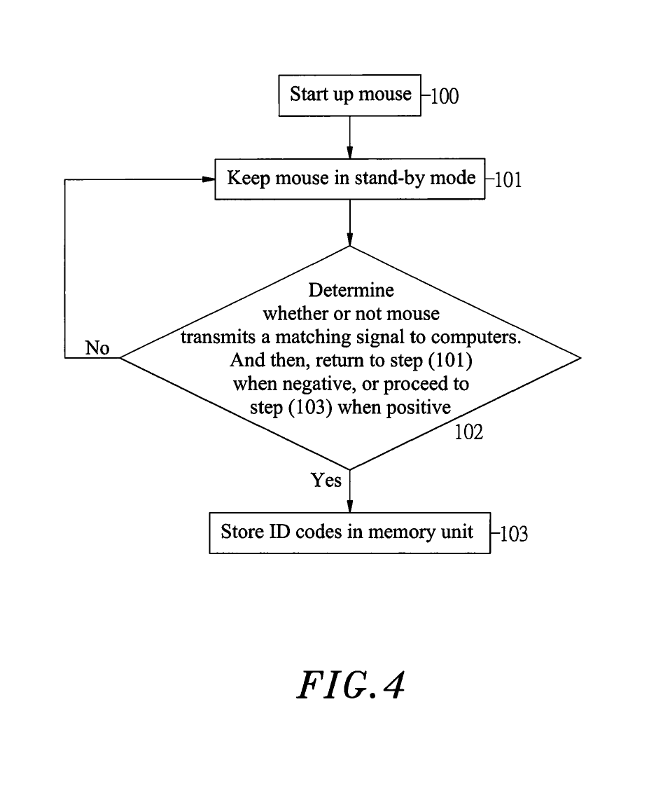

Referring to FIGS. 3 and 4, each mouse 3 is operable for switching and operating the computers 4. Before matching with the computers 4, i.e., when the memory unit 311 in each mouse 3 has no any ID code of the computers 4, each mouse 3 is initialized subject to the following steps:
(100) Start up the mouse 3.
(101) Keep the mouse 3 in stand-by mode.
(102) Determine whether or not the mouse 3 transmits a matching signal to the computers 4. And then, return to step (101) when negative, or proceed to step (103) when positive.
(103) Store the ID codes in the memory unit 311 of the mouse 3.

After each mouse 3 has been started up, run stand-by mode. This stand-by mode includes the operation in which the displacement sensor module 35 transmits a displacement signal through the wireless transmitter and receiver unit 313 to the computers 4 for cursor control and the operation in which the operating module 34 transmits a key signal through the wireless transmitter and receiver unit 313 to the computers 4 for, for example, pump-down operation. i.e., any condition that does not cause generation of a switching signal or matching signal is included in the stand-by mode.

After initialization of each mouse 3, the memory unit 311 does not have the ID codes of the computers 4. When a user operates the switch module 32 or the operating module 34 that has the switching function, the mouse 3 will transmit a matching signal through the wireless transmitter and receiver unit 313 to the computers 4. Upon receipt of the matching signal, each computer 4 will transmit its ID code to the mouse 3. After receipt of the ID code of each computer 4 through the wireless transmitter and receiver unit 313, the control unit 312 of the mouse 3 will store the ID codes of the computers 4 in the memory unit 311. Subject to the aforesaid operation procedure, the memory unit 311 of each mouse 3 has the ID codes of the computer 4 stored therein. Further, the ID code of each computer 4 can be the address of the wireless receiver of the respective computer 4, the serial number of the user of the respective computer 4, or the serial number of the respective computer 4.

The method of setting the matching between the switching signals and the ID codes can be done by corresponding the ID code receiving and storing sequence to the sequence of the switching signals preset in the switch module 32 or operating module 34, i.e., if the switch module 32 or operating module 34 is set to produce three switching signals in the sequence of first switching signal, second switching signal and third switching signal, the first switching signal corresponds to the ID code that is stored in the memory unit 311 at the first place, the second switching signal corresponds to the ID code that is stored in the memory unit 311 at the second place, and the third switching signal corresponds to the ID code that is stored in the memory unit 311 at the third place. It is to be understood that the aforesaid method is simple an example but not a limitation. Other techniques may be employed to set the matching between the switching signals and the ID codes.

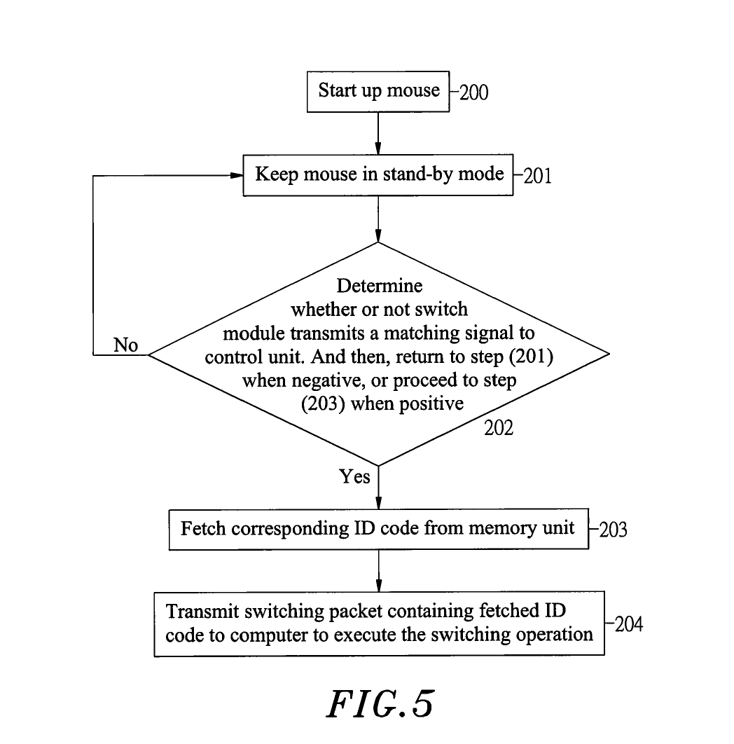

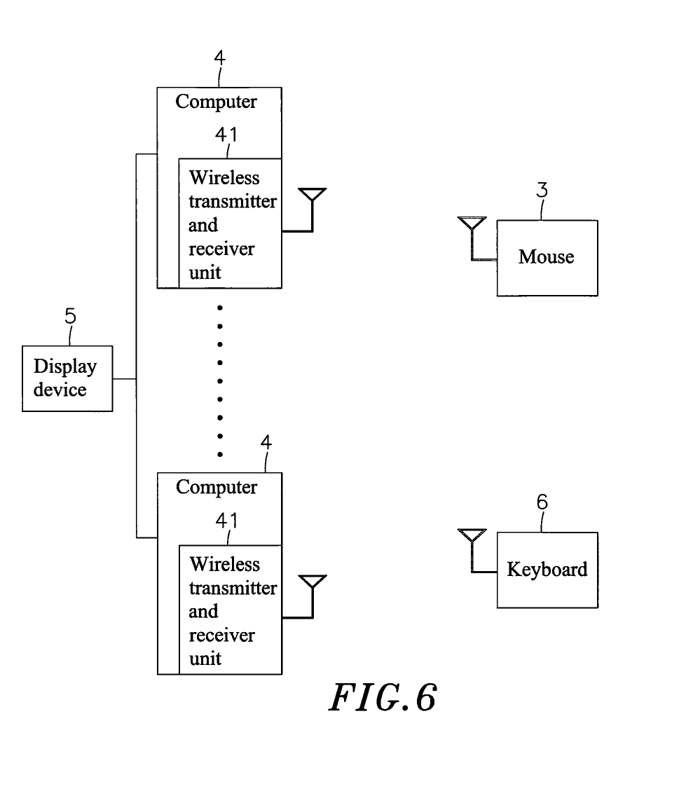

Referring to FIG. 5 and FIGS. 3 and 4 again, after initialization of each mouse 3 and storage of the ID codes of the computers 4 in the memory unit 311 in each mouse 3, the switching operation runs subject to the steps:
(200) Start up the mouse 3.
(201) Keep the mouse 3 in stand-by mode.
(202) Determine whether or not the switch module 32 of the mouse 3 transmits a matching signal to the control unit 312 of the mouse 3. And then, return to step (201) when negative, or proceed to step (203) when positive.
(203) Fetch the corresponding ID code from the memory unit 311 of the mouse 3.
(204) Transmit a switching packet containing the fetched ID code to the computers 4 to execute the switching operation.

After startup of the mouse 3, it enters stand-by mode. This stand-by mode is same as the stand-by mode described early, i.e., any condition that does not cause generation of a switching signal or matching signal is included in the stand-by mode. If the memory unit 311 of the mouse 3 that has been started up has stored therein the ID codes of the computers 4, the mouse 3 will determine whether or not the switch module 32 has been clicked. If positive, the switch module 32 will provide a switching signal to the control unit 312, and the control unit 312 will fetch the corresponding ID code from the memory unit 311 and then transmit a switching packet containing the fetched ID code through the wireless transmitter and receiver unit 313 to the computers 4. Upon receipt of the switching packet, each computer 4 will compare the ID code to its storage data for matching. When matched, the respective computer 4 will re-establish the connection with the corresponding mouse 3 by transmitting the ID code to the mouse 3, enabling the wireless transmitter and receiver unit 313 to transmit the ID code to the control unit 312 for matching. When matched, the connection between the computer and the mouse 3 is established. When the ID code is not matched, the signal will be refused or denied. Thus, this mouse 3 can be operated to switch the connection from one computer 4 to another, and then to control the assigned computer 4 in transmitting a video signal to the display device 5. Subject to the application of the present invention, an operator can use one single input device, for example, mouse 3 to control multiple computers 4 wirelessly from a remote place.

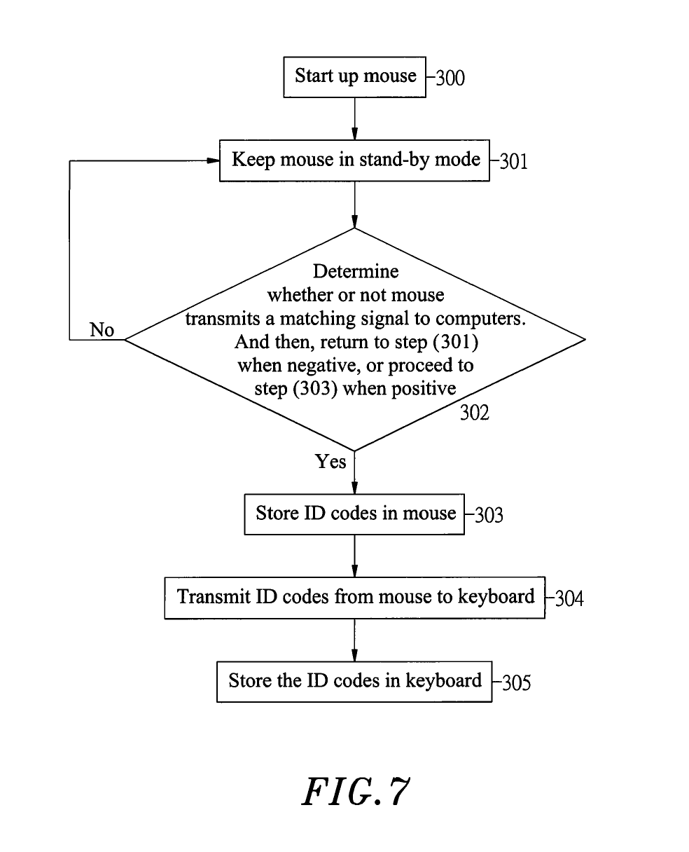

Referring to FIGS. 6 and 7 and FIGS. 1 and 3 again, the multimedia operating system according to this alternate form comprises a plurality of input devices, for example, one mouse 3 and one keyboard 6, a plurality of computers 4 and a display device 5. The aforesaid manipulation module 1 can also be installed in the keyboard 6. The initialization setting runs subject to the following steps:
(300) Start up the mouse 3.
(301) Keep the mouse 3 in stand-by mode.
(302) Determine whether or not the mouse 3 transmits a matching signal to the computers 4. And then return to step (301) when negative, or proceed to step (303) when positive.
(303) Store the ID codes in the mouse 3.
(304) Transmit the ID codes from the mouse 3 to the keyboard 6.
(305) Store the ID codes in the keyboard 6.

After matching of one of the multiple input devices, for example, after matching of the mouse 3 with the computers 4, the mouse 3 receives and stores the ID codes of the computers 4. Thereafter, the other input device, i.e., the keyboard 6 can receive the matched ID codes from the mouse 3 and stores them in its internal memory. Thus, when one input device, for example, the mouse 3 finished a matching operation to store the ID codes of the computers 4, the other input device, i.e., the keyboard 6 can update its storage ID codes. On the contrary, when the keyboard 6 finished a matching operation, the mouse 3 can receive the newly matched ID codes from the keyboard 6 and then store the newly matched ID codes in its memory. According to the present invention, any of the input devices of the multimedia operating system can be controlled to actively establish matching with the installed computers and to transmit the ID codes of the computers to the other input device.

Referring to FIG. 8 and FIGS. 3, 6 and 7 again, after initialization of the mouse 3 and the keyboard 6 and storage of the ID codes of the computers 4 in the mouse 3 and the keyboard 6, the switching operation runs subject to the following steps:
(400) Start up the mouse 3.
(401) Keep the mouse 3 in stand-by mode.
(402) Determine the switch module 32 of the mouse 3 transmits a matching signal to the control unit 312 of the mouse 3. And then, return to step (401) when negative, or proceed to step (403) when positive.
(403) Fetch the corresponding ID code from the memory unit 311 of the mouse 3.
(404) Transmit a switching packet containing the fetched ID code to the keyboard 6 to execute the switching operation
(405) Transmit a switching packet containing the fetched ID code to the computers 4 to execute the switching operation.

When one of the multiple input devices, for example, when the mouse 3 runs the aforesaid switching procedure, the other input device, i.e., the keyboard 6 can receive the switching packet from the mouse 3 and fetch the corresponding ID code from its memory unit subject to the content of the received switching packet and then transmit a switching packet containing the fetched ID code to the computers 4. When the ID code in the switching packet is recognized by one computer 4 after matching, the computer 4 re-establishes the connection with the mouse 3 and the keyboard 6 for transmission of key signals or displacement signals between there. This method facilitates the operator to use any of the input devices 3;6 for controlling the operation of the computers 4. Simply by clicking the switch module 32 or operating module 34 of any of the input devices 3;6, the operator can switch the other input device and the computers 4. Thus, any of the input devices of the multimedia operating system can be controlled to actively transmit the ID codes or switching packet.

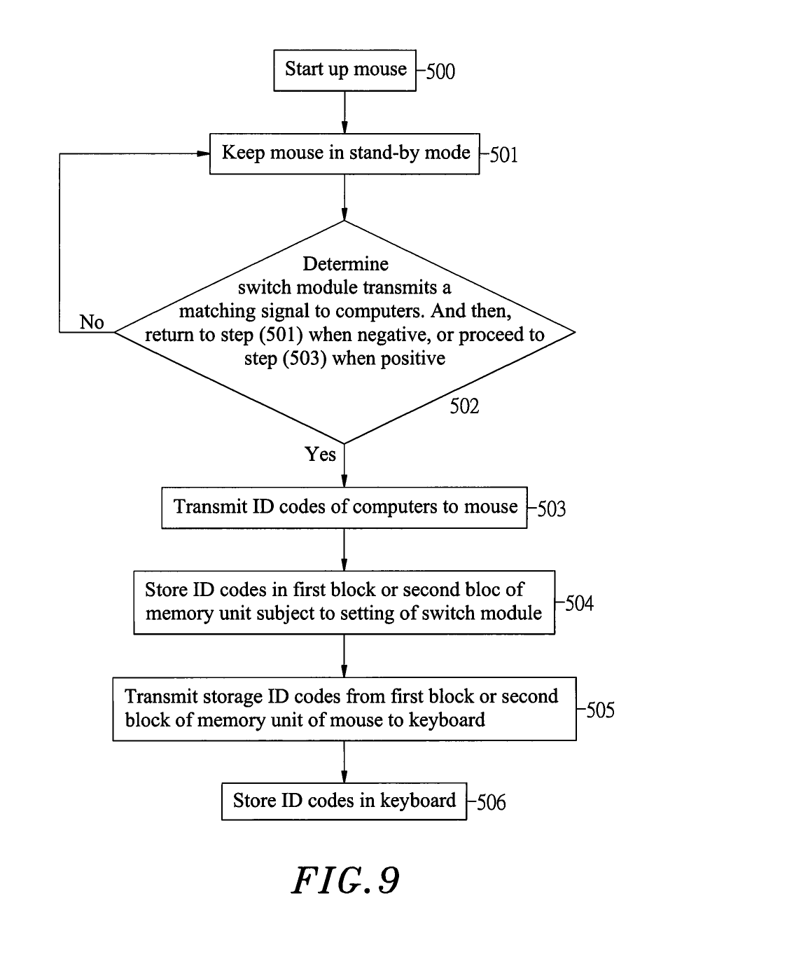

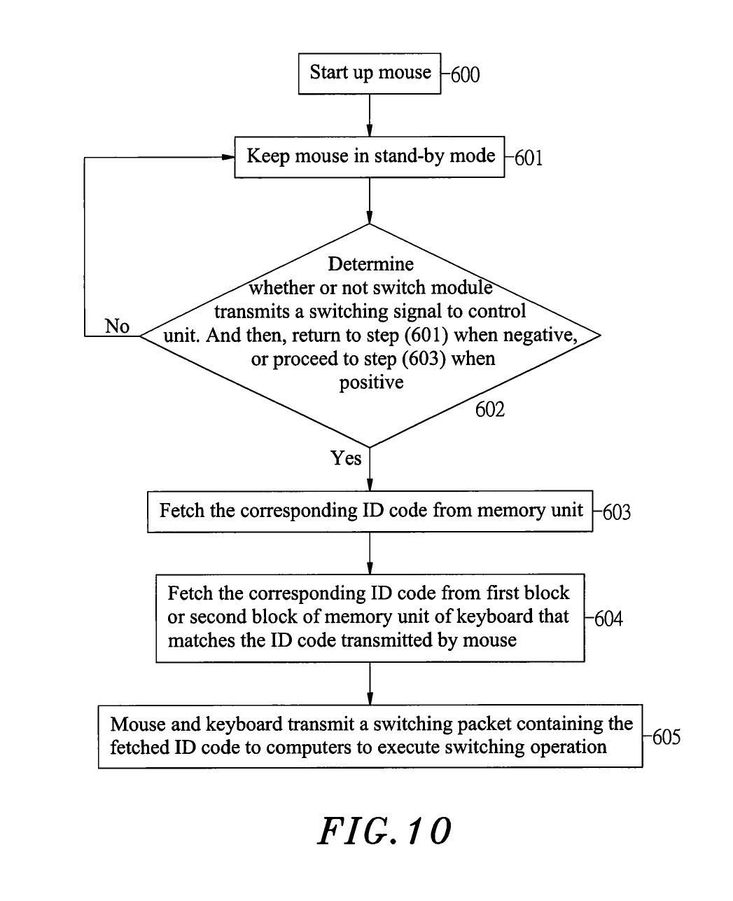

Referring to FIG. 9 and FIGS. 3 and 6, the multimedia operating system includes multiple input devices, for example, multiple mice 3 and/or keyboards 6, each input device having built therein a manipulation module 1. If the memory unit 311 of each input device is divided into multiple memory blocks, for example, a first block and a second block and, the assigned mice 3 and keyboards 6 are of the same group, the initialization runs subject to the following steps:
(500) Start up the mouse 3.
(501) Keep the mouse 3 in stand-by mode.
(502) Determine whether or not the mouse 3 transmits a matching signal to the computers 4. And then return to step (501) when negative, or proceed to step (503) when positive.
(503) Transmit the ID codes of the computers 4 to the mouse 3.
(504) Store the ID codes in the first block or second block of the memory unit 311 subject setting of the switch module 32.
(505) Transmit the storage ID codes from the first block or second block of the memory unit 311 of the mouse 3 to the keyboard 6.
(506) Store the ID codes in the keyboard 6.

The stand-by mode of the mouse 3 is same as explained before. After matching of the multiple mice 3 with the computers 4, the computers 4 transmit their ID codes to the multiple mice 3 for storing in the multiple mice 3. The memory unit 311 of each mouse 3 is divided into a first block and a second block. The multiple ID codes can be respectively stored in the first block and second block of the memory unit 311 of one mouse 3, and synchronously stored in the first block and second block of the memory unit of another input device, for example, keyboard 6. Thus, multiple input devices can run setting and switching synchronously.

In more detail, multiple mice 3 and keyboards 6 are defined to be the same group in such a manner that the mice 3 and the keyboards 6 trigger the respective switch module 22 or operating module 24, and simultaneously transmit the same switching signal, and store the same group of ID codes in the respective first block or second block. If one mouse 3 and one keyboard 6 simultaneously transmit the same switching signal, the ID codes are stored in the second block for further switching operation.

Referring to FIG. 10 and FIGS. 3 and 6 again, when a switching operation is performed in a multimedia operating system comprising multiple input devices, the switching operation runs subject to the following steps:
(600) Start up the mouse 3.
(601) Keep the mouse 3 in stand-by mode.
(602) Determine whether or not the switch module 32 of the mouse 3 transmits a switching signal to the control unit 312. And then, return to step (601) when negative, or proceed to step (603) when positive.
(603) Fetch the corresponding ID code from the memory unit 311 of the mouse 3.
(604) Fetch the corresponding ID code from the first block or second block of the memory unit of the keyboard 6 that matches the ID code transmitted by the mouse 3.
(605) The mouse 3 and the keyboard 6 transmit a switching packet containing the fetched ID code to the computers 4 to execute the switching operation.

When one mouse 3 transmits a switching packet, the matching keyboard 6 will receive the switching packet and determines the ID code in the received switching packet to be from the first block or second block, and then will transmit a switching packet containing the related ID code and switching signal to the computers 4 to execute the switching operation.

In the aforesaid procedure, each input device 3 or 6 can release from the matching status or group status. For example, the operating module 34 of one mouse 3 comprises a reset key (not shown). When a user clicks the reset key, the input device 3 or 6 is released from the current matching status or group status, and can make a new matching or establish a new group. As stated above, the data to be transmitted between the input devices and the computers includes, but not limited to, key switch signals, displacement signals and switching packets.

Further, the input devices constructed according to the present invention, except the forms of the mouse 2, mouse 3 and keyboard 6, can be of any other designs.

In conclusion, the invention provides an input device that allows a user to control multiple computers from a remote place has advantages and features as follows:
1. The manipulation module 1 is operable to control switching of multiple computers 4 wirelessly from a remote place, so as to store the ID codes of the computers 4 in the memory unit 11 thereof. When the manipulation module 1 receives an external switching signal, it fetches the corresponding ID code from its memory unit 11 and then transmits a switching packet to the computers 4 to execute the switching operation. Thus, a user can control multiple computers from the input device without any extra switching device, such as KVM switch, saving the cost.
2. The input device can receive a switching packet from another input device having the same function. Thus, switching one single input device causes the other matting input devices to be simultaneously automatically switched, facilitating operation.
3. Multiple input devices can be defined as a group, and the memory unit of each of the input devices of the same group is divided into a first block and a second block, and multiple ID codes are respectively stored in the first block and second block of the memory unit. Thus, the switching operation of the input devices of one same group does not interfere with the operation of the input devices of another group, avoiding errors.

Although particular embodiments of the invention have been described in detail for purposes of illustration, various modifications and enhancements may be made without departing from the spirit and scope of the invention. Accordingly, the invention is not to be limited except as by the appended claims.

What the invention claimed is:

1. An input device used in a multimedia operating system for controlling multiple computers of said multimedia operating system wirelessly, comprising:
a memory unit adapted for storing the ID codes of the computers of said multimedia operating system;
a control unit electrically connected with said memory unit and adapted for receiving an external switching signal and fetching at least one ID code from said memory unit subject to the content of the received external switching signal and then producing a switching packet containing the fetched at least one ID code;
a wireless transmitter and receiver unit electrically connected with said control unit and adapted for transmitting the switching packet produced by said control unit to a wireless transmitter and receiver of each of said computers of said multimedia operating system; and
a power supply unit electrically connected with said control unit and adapted for providing the input device with the necessary working power supply.

2. The input device as claimed in claim 1, further comprising a display device electrically connected with said control unit for displaying the switching status.

3. The input device as claimed in claim 2, wherein said display device is selected from the group of LED display means, 7-segment display means, TFT-LCD display means.

4. The input device as claimed in claim 1, wherein said wireless transmitter and receiver unit is selected from the group of Bluetooth, radio frequency (RF) and Worldwide Interoperability for Microwave Access (WiMax) interface designs.

5. The input device as claimed in claim 1, wherein said control unit is selected from the group of microprocessor, micro control unit (MCU), controller and central processing unit (CPU).

6. The input device as claimed in claim 1, wherein the ID code of each said computer is one of the address of the wireless receiver of the wireless transmitter and receiver unit of the respective computer, the serial number of the user of the respective computer and the serial number of the respective computer.

7. The input device as claimed in claim 1, which is one of a mouse, a keyboard and a touch panel.

8. The input device as claimed in claim 1, further comprising an operating module electrically connected with said control unit and adapted for transmitting a key signal to said computers.

9. The input device as claimed in claim 8, wherein said key signal is one of an icon-control key signal, letter key signal, symbol key signal.

10. The input device as claimed in claim 1, wherein said external switching signal is transmitted by a mating input device by a wired transmitting method to the control unit thereof.

11. The input device as claimed in claim 1, wherein said external switching signal is transmitted wirelessly by a mating input device to the control unit thereof through the wireless transmitter and receiver unit thereof.
